(19) United States
(12) Patent Application Publication
(10) Pub. No.: US 2014/0045130 A1
(43) Pub. Date: Feb. 13, 2014

(54) Method for heating a shaped component for a subsequent press hardening operation and continuous furnace for regionally heating a shaped component preheated to a predetermined temperature to a higher temperature

(71) Applicants: Gerald Eckertsberger, Wilhering (AT); Eduard Morbitzer, Linz (AT); Robert Ebner, Leonding (AT); Fritz Josef Ebner, Leonding (AT)

(72) Inventors: Gerald Eckertsberger, Wilhering (AT); Eduard Morbitzer, Linz (AT); Robert Ebner, Leonding (AT); Fritz Josef Ebner, Leonding (AT)

(73) Assignee: EBNER INDUSTRIEOFENBAU GMBH, Leonding (AT)

(21) Appl. No.: 14/112,634

(22) PCT Filed: Jun. 30, 2011
(86) PCT No.: PCT/AT2011/000286

§ 371 Date: Oct. 18, 2013

(51) Int. Cl. F27B 9/36; F27B 9/40

(52) U.S. Cl. CPC F27B 9/36; F27B 9/40
USPC 432/18; 432/122

(57) ABSTRACT

A method for heating a shaped component (2) for a subsequent press hardening operation is described, wherein the shaped component (2) is firstly heated to a predefined temperature and subsequently regionally heated to a higher temperature by means of heating elements (7), which are drivable independently of one another, of a heating element panel (10). In order to ensure an advantageous temperature profile, it is proposed that the shaped component (2) be heated during its conveyance through the heating element panel (10) with the aid of the heating elements (7), which are arranged with respect to the conveyance direction (3) in longitudinal and transverse rows (8 and 9) and are drivable at least in groups using differing heating power.

### PANEL OF THE INVENTION

The invention relates to a method for heating a shaped component for a subsequent press hardening operation, wherein the shaped component is firstly heated to a predefined temperature and subsequently regionally heated to a higher temperature by means of heating elements, which are drivable independently of one another, of a heating element panel.

### DESCRIPTION OF THE PRIOR ART

In the case of press hardening of shaped components heated to predefined treatment temperatures, due to the uneven cooling over the cooled pressing tools, hardness microstructures arise, which can result in the case of austenitic steels in tensile strengths of greater than 1500 MPa at an extension in the range of 6%. Such high tensile strengths are frequently only necessary in sub-regions of the workpiece, however, while in other regions higher extensions of 15 to 17% are required, for example. In order to ensure these material properties which differ by region, it has already been proposed that the shaped components be subjected before the press hardening to differing heat treatment in the respective subregions, so that the shaped components are only heated to a temperature above the AC₃ point of the alloy in the regions of higher tensile strength, which results in a corresponding microstructure conversion under the conditions of subsequent press hardening. For this purpose, providing cooling bodies in the regions of lower tensile strength is known (DE 10 2006 018 406 A1), which cooling bodies dissipate a part of the heat supplied to the shaped components with the consequence that the sections of the shaped components in the regions of the cooling bodies remain below the temperature required for the formation of an austenitic microstructure. However, the comparatively high power requirement is disadvantageous. In order that the power use can be restricted to the respective required extent, dividing a continuous furnace transversely through the passage direction into at least two sections heatable separately from one another is known (EP 1 426 454 A1). The shaped component extending transversely to the conveyance direction over at least two such sections can therefore be heated regionally to different treatment temperatures, however, more precise temperature control is hardly possible in the different subregions of the shaped components to be heated.

In order to allow advantageous regional heating of a shaped component to a temperature above the AC₃ point, it has additionally already been proposed (EP 2 143 808 A1), that the shaped component firstly be heated in a joint heating operation to a temperature below the AC₃ point, before only the regions provided for the formation of an austenitic microstructure are heated to the temperature above the AC₃ point, specifically with the aid of a panel of infrared lamps, which can be switched independently of one another, so that additional heat energy is only introduced into the shaped component in the regions of the turned-on infrared lamps. Such additional regional heating of the shaped component precludes heat treatment of the shaped components in continuous operation, however.

Finally, applying hot gas to shaped components in a continuous furnace via nozzle panels is known (EP 2 090 667 A1), wherein the individual nozzles, which are arranged in longitudinal and transverse rows with respect to the conveyance direction, of the nozzle panels can be driven independently of one another. This nozzle driving independent of one another allows a nozzle selection adapted to the outline shape of the shaped components, so that the hot gas application can be restricted to the region of the respective shaped component.

### SUMMARY OF THE INVENTION

The invention is therefore based on the problem of embodying a method for heating a shaped component to different temperatures such that in spite of a continuous passage, the shaped components can be subjected to a heat treatment, which is required for the subsequent press hardening operation, with improved temperature control within the different parts to be heated.

Proceeding from a method of the type described at the beginning for heating a shaped component for a subsequent press hardening operation, the invention achieves the stated problem in that the shaped component is heated during its conveyance through the heating element panel with the aid of heating elements, which are arranged with respect to the conveyance direction in longitudinal and transverse rows, and can be driven at least in groups using different heating power.

Since as a result of this measure, the heating elements can be driven with differing heating power, firstly a substantial requirement for improved temperature control of the shaped components is fulfilled. With the possibility of driving the heating elements of both the longitudinal rows and also the transverse rows independently of one another at least in groups, in addition the temperature of the shaped components can be influenced in a longitudinal strip extending in the conveyance direction during the component conveyance, so as not only to reach predefined temperature levels in the region of such longitudinal strips, but rather also be able to maintain them for a predefined time. It is therefore possible, for example, based on the dimensions and therefore the mass distribution of the shaped components, to compensate for different temperature regions during the heating of the shaped components to the predefined starting temperature or, if needed, to amplify them, so that after reaching the respective treatment temperature, this treatment temperature, which differs in different regions, can also be maintained during a predefined treatment time.

For additional influence on the temperature control in the region of the sections of the shaped components to be subjected to differing heat treatment, the shaped components can be cooled via optionally drivable cooling units in the conveyance direction, which are assigned to the longitudinal rows of the heating elements. This optionally usable cooling allows an additional heat dissipation in a way known per se, which if needed makes maintaining a predefined temperature level easier during the regional heat treatment of the shaped components. The heat losses linked to such heat dissipation have to be accepted, however.

To carry out a heating method according to the invention, one can proceed from a continuous furnace for the regional heating of a shaped component preheated to a predefined temperature to a higher temperature having a conveyor penetrating a furnace housing for the shaped components and having a heating element panel, which is assigned to the conveyor, made of heating elements drivable individually independently of one another. If the heating elements, which are arranged in longitudinal and transverse rows with respect to the conveyance direction of the conveyor, are activated at least in groups with differing heating powers in the longitudinal and transverse directions, additional heat can be introduced into the shaped component to be treated sensitively in the region of the longitudinal rows of the heating elements over the length of the heating element panel such that in the respective longitudinal strips of the shaped component, a predefined temperature control can be maintained over the length of the continuous furnace, and substantially independently from the temperature control in an adjacent longitudinal strip.

Although it only relates to the controlled introduction of the respective required additional quantities of heat into the shaped component to be treated, so that different heating elements could be used, particularly advantageous design conditions result if the heating elements are implemented as electrical resistance heaters, because in this case the controller of the heating power of these heating elements can be designed particularly simply.

To be able to dissipate heat as needed in the region of the longitudinal strips of the shaped components, optionally drivable cooling units can be assigned to the longitudinal rows of the heating elements. An additional delimitation of these possible cooling zones can be achieved by partition webs between the cooling units, which form thermal insulation between the longitudinal rows of the heating elements.

The effect of these cooling units is dependent on the distance thereof from the region of the shaped components to be cooled, of course. For this reason, particularly advantageous design conditions for such cooling units result if the heating elements are arranged in a jacket pipe connectable to a cooling air fan, so that the distance between the longitudinal strips of the shaped components to be cooled and the cooling units can be kept small, without impairing the heating power. The jacket pipes are disconnected from the cooling air fan during the driving of the heating elements, of course. However, the cooling effect can be increased in that a cooling gas is blown onto the region of the shaped component to be treated via the jacket pipes of the heating elements.

### BRIEF DESCRIPTION OF THE DRAWING

The method according to the invention will be explained in greater detail on the basis of the drawing. In the figures

FIG. 1 shows a continuous furnace according to the invention in a schematic cross-section,

FIG. 2 shows the distribution of the heating elements of a heating element panel of the continuous furnace in a schematic block diagram, and

FIG. 3 shows the temperature profile in the region of individual longitudinal strips of a shaped component during its conveyance through the continuous furnace.

### DESCRIPTION OF THE PREFERRED EMBODIMENT

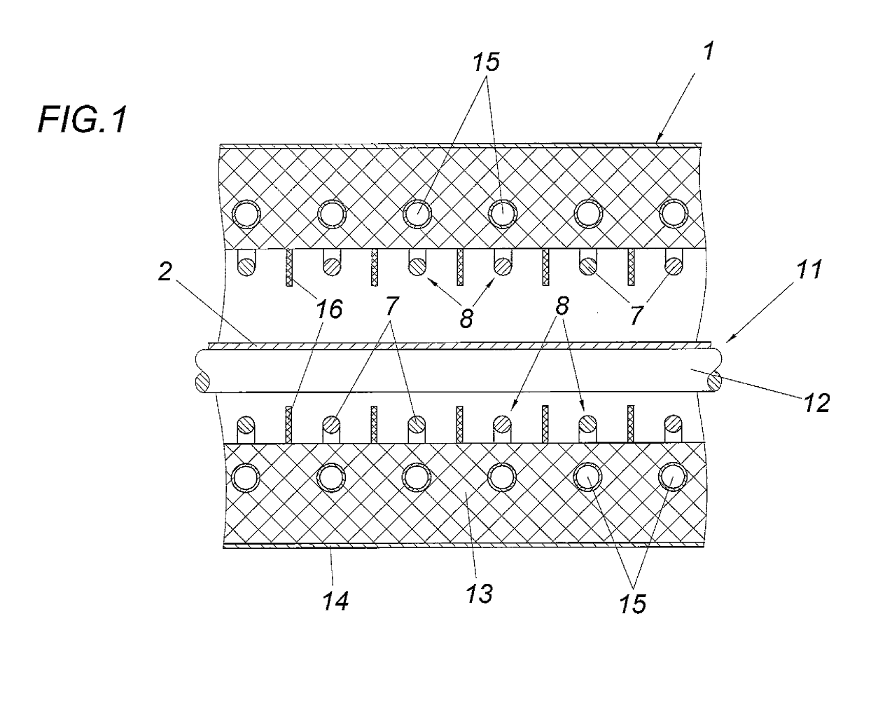

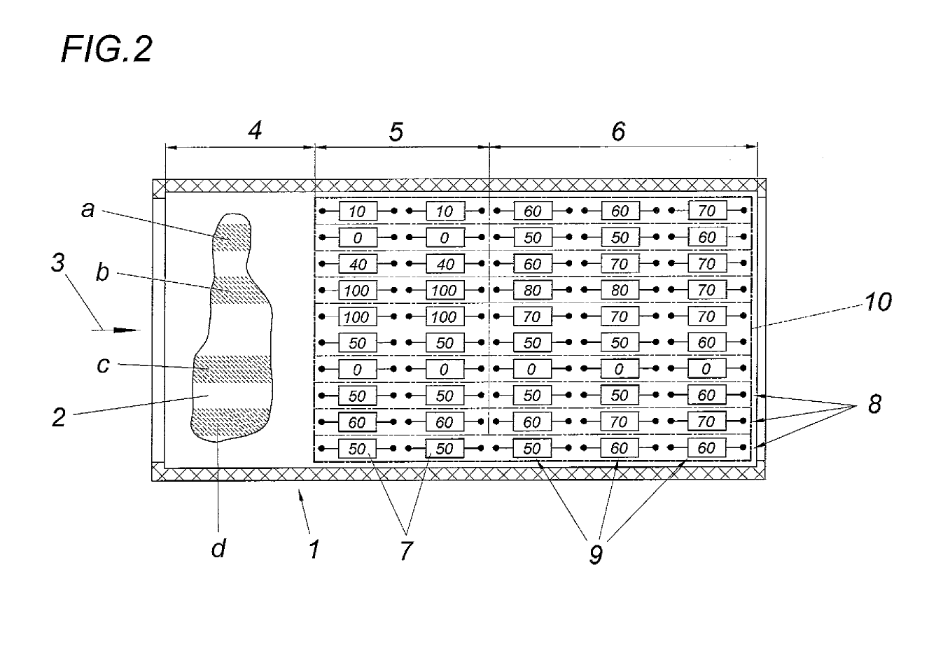

The block diagram according to FIG. 2 shows a continuous furnace 1 for the heat treatment of shaped components 2, which are introduced as sheet metal blanks into the continuous furnace 1, which comprises, in the conveyance direction 3, successively a heating zone 4, which is continuous over the furnace width, for heating the shaped component 2 to a predefined temperature, a heating zone 5 for regional heating of the shaped component 2 in longitudinal strips with respect to the conveyance direction 3, and a holding zone 6, in order to be able to use the differing temperature profiles during the subsequent press hardening operation to implement different microstructures in individual longitudinal strips. Heating elements 7 are provided in the heating zone 5 and the holding zone 6 in longitudinal rows 8 and transverse rows 9 of a heating element panel 10. The shaped components 2 are conveyed through the continuous furnace 1 by means of a conveyor 11, whose conveyor rollers are designated in FIG. 1 with 12. The heating elements 7 are provided above and below the conveyor 11. The furnace housing 14, which is lined with thermal insulation 13, has, in the region of the longitudinal rows 8 of the heating elements 7, cooling units 15 in the form of cooling pipes, which can optionally be connected to a cooling fan. These cooling pipes can, in an alteration of the embodiment according to FIG. 1, represent jacket pipes of the heating elements 7, so that because of this implementation the cooling units 15 come to rest closer to the shaped components 2, which improves the cooling effect at a given cooling power. Partition webs 16, which form thermal insulation, in order to be able to better delimit the cooling zones from one another or with respect to the adjacent heating zones, can be provided between the individual cooling zones provided by the cooling units 15.

The heating elements 7 are preferably implemented as electrical resistance heaters, which can be driven independently of one another at least in groups using differing heating power. In FIG. 2, the percentage proportion of the heating power is indicated, with which the individual heating elements 7 are driven. In the case of the specification 100, this means that the heating elements 7 are driven using the full heating power, however, the heating elements 7 having the specification 0 are turned off, while the specification 50 designates driving of the heating elements 7 at half heating power.

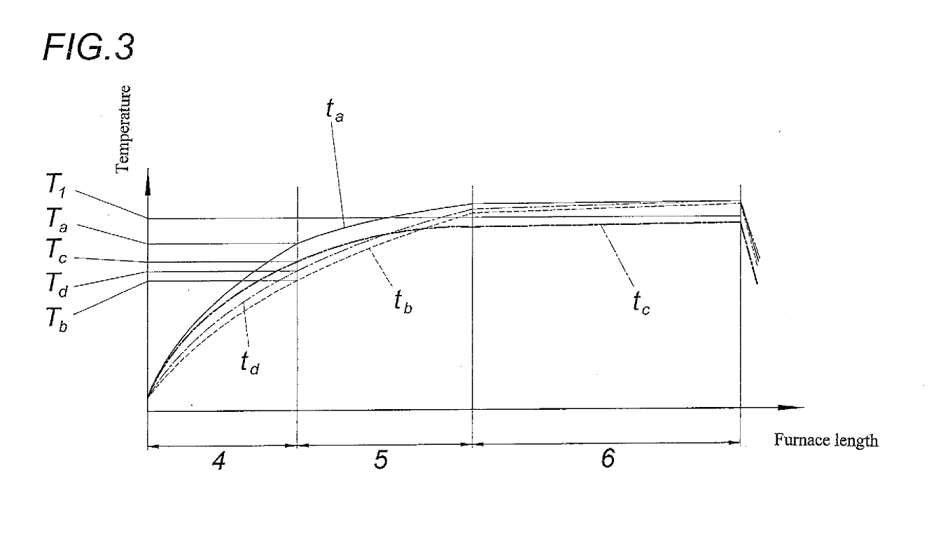

FIG. 3 shows the temperature profile in selected longitudinal strips a, b, c, d with respect to the conveyance direction 3 of the shaped component 2 during the furnace passage in the case of the driving of the heating elements 7 using the heating powers specified for the individual heating elements 7. It is shown that in the shared heating zone 4, the shaped component 2 is heated to a predefined temperature below the temperature T₁ for the AC₃ point. Because of the mass distribution, different temperatures Tₐ, T_{b}, T_{c}, T_{d} result at the outlet of the heating zone 4 for the individual longitudinal strips a, b, c, d of the shaped component 2. While in the longitudinal strips a, b, and d, the temperature in the heating zone 5 is to be increased above the temperature T₁ of the AC₃ point, the temperature in the region of the longitudinal strip c is to be kept below the temperature T₁. For this reason, the heating elements 7 of the longitudinal row 8 of the heating element panel 10 associated with the longitudinal strip c are turned off, so that in the area of the heating zone 5, only a slight heat introduction results via the heating elements 7 of the adjacent longitudinal rows 8, which are each driven at half heating power. The temperature profile t_{c} for this longitudinal strip c shows this state of affairs. The temperature profile tₐ would result in the case of continued heating in a high treatment temperature at the outlet of the heating zone 5. For this reason, in the area of the longitudinal strip a, a throttled heat supply is ensured solely via the heating elements 7 of the adjacent longitudinal rows 8 of the heating element panel 10, as is obvious on the basis of the temperature profile tₐ in the region of the heating zone 5. Since the starting temperatures of the heating zone 4 for the longitudinal strips b and d are comparatively low, a stronger heat introduction into these longitudinal strips b and d is necessary in the region of the heating zone 5 in order to ensure the respective holding temperatures at the outlet of the heating zone 5. The heating elements 7 associated with the longitudinal strips b and d in the heating zone 5 therefore have full heating power applied in the region of the longitudinal strip b and 60% of the heating power applied in the region of the longitudinal strip d, so that the curve profile t_{b} or t_{d} results, respectively, using which the holding temperatures can be ensured at the outlet of the heating zone 5 for the associated longitudinal strips b, d.

For holding the treatment temperatures at the outlet of the heating zone 5, the heating elements 7 of the holding zone 6 associated with the individual longitudinal strips are driven using a corresponding power. In consideration of the respective heating powers of the heating elements 7 of the adjacent longitudinal rows 8, a heating power of respectively 50%, which is raised in the region of the last heating element to 60%, results for maintaining the temperature profile tₐ. The temperature profile t_{b} is ensured by the succession of the heating elements 7 in the associated longitudinal row 8, which are driven at 80% or 70%, respectively, of the heating power. For the longitudinal strip d of the shaped component 2, the heating elements 7 in the holding zone 6 are initially driven at 60% and then at 70% of the heating power. Because of this sensitive control of the quantity of heat introduced in strips into the shaped component, a predefined temperature profile can advantageously be maintained, wherein with the aid of the additional cooling capability indicated in FIG. 1, a further adaptation possibility is opened up if a predefined temperature profile requires the additional cooling of a strip region. In spite of the continuous passage of the shaped components 2 through the continuous furnace 1, therefore different heat conditions can be achieved in different regions of the shaped components as a requirement for the implementation of different microstructures by the subsequent press hardening operation. Due to the joint preheating of all component regions to a predefined starting temperature before the regional heating of the shaped components, not only are favorable efficiencies for the differing heating of the shaped components made possible, but rather also advantageous heat treatment of coated shaped components is achieved, because diffusion of the coating into the shaped component is ensured with the joint preheating of all component regions.

1. A method for heating a shaped component (2) for a subsequent press hardening operation, wherein the shaped component (2) is firstly heated to a predefined temperature and subsequently regionally heated to a higher temperature by means of heating elements (7), which are drivable independently of one another, of a heating element panel (10), wherein the shaped component (2) is heated during its conveyance through the heating element panel (10) with the aid of the heating elements (7), which are arranged with respect to the conveyance direction (3) in longitudinal and transverse rows (8 and 9) and are drivable at least in groups using differing heating power.

2. The method according to claim 1, wherein the shaped component (2) can be cooled in strips in the conveyance direction (3) via optionally drivable cooling units (15), which are assigned to the longitudinal rows (8) of the heating elements (7).

3. A continuous furnace (1) for the regional heating of a shaped component (2) preheated to a predefined temperature to a higher temperature, having a conveyor (11) penetrating a furnace housing (14) for the shaped component (2) and having a heating element panel (10), which is assigned to the conveyor (11), made of heating elements (7) individually drivable independently of one another, wherein the heating elements (7), which are arranged in longitudinal and transverse rows (8, 9) with respect to the conveyance direction (3) of the conveyor (11), are drivable using differing heating powers at least in groups in the longitudinal and transverse directions.

4. The continuous furnace (1) according to claim 3, wherein the heating elements (7) are implemented as electrical resistance heaters.

5. The continuous furnace (1) according to claim 3, wherein optionally activatable cooling units (15) are assigned to the longitudinal rows (8) of the heating elements (7).

6. The continuous furnace (1) according to claim 5, wherein the heating elements (7) are arranged in a jacket pipe connectable to a cooling air fan.
